(19) United States
(12) Patent Application Publication
(10) Pub. No.: US 2013/0239831 A1
(43) Pub. Date: Sep. 19, 2013

(54) PRINTING DEVICE AND PRINTING METHOD

(71) Applicant: LG CHEM, LTD., Seoul (KR)

(72) Inventors: Seung Heon Lee, Daejeon (KR); Beom Mo Koo, Daejeon (KR); In-Seok Hwang, Daejeon (KR); Sang Ki Chun, Daejeon (KR); Ji Young Hwang, Daejeon (KR); Yong Goo Son, Daejeon (KR)

(21) Appl. No.: 13/989,362

(22) PCT Filed: Mar. 30, 2012
(86) PCT No.: PCT/KR2012/002403

§ 371 Date: May 23, 2013

(30) Foreign Application Priority Data
Apr. 1, 2011 (KR) 10-2011-0030031

(51) Int. Cl. B41F 1/16

(52) U.S. Cl. CPC B41F 1/16
USPC 101/142; 101/492

(57) ABSTRACT

Provided are a reverse offset printing apparatus and a reverse offset printing method, including: a printed film supplying unit and a printed film collecting unit for continuously supplying a printed film; a printed film supporting unit provided between the printed film supplying unit and the printed film collecting unit; a printing roll for transferring a printed matter pattern to the printed film on the printed film supporting unit, in which the printed roll is provided so that a progress direction of the printed film is parallel to a rotation direction of the printing roll at a place where the printed matter pattern is transferred; a coating unit coating a printed matter on the printing roll; and a cliché provided on a stage for mounting the cliché in order to form the printed matter pattern on the printing roll.

### CROSS-REFERENCE TO RELATED APPLICATIONS

This application claims priority to and the benefit of Korean Patent Application No. 10-2011-0030031 filed in the Korean Intellectual Property Office on Apr. 1, 2011, the entire contents of which are incorporated herein by reference.

### TECHNICAL FIELD

The present invention relates to a printing apparatus and a printing method. Particularly, the present invention relates to a reverse offset printing apparatus and a reverse offset printing method using the same.

### BACKGROUND ART

Recently, patterns of various functional materials have been required in electronic devices. For example, a conductive pattern for an electrode, black matrix pattern and color pattern for a color filter, insulation pattern and resist pattern for a thin film transistor (TFT), and the like have been required.

The patterns may be formed by a photolithography method and the like, but by considering process cost or efficiency, a method of forming a pattern using a printing method is being attempted.

In the printing method, there are various problems to be preceded such as an alignment problem for forming a pattern at an exact location of a printed matter.

### SUMMARY OF THE INVENTION

The present invention has been made in an effort to provide a method or apparatus of forming an electronic material pattern capable of precisely forming the electronic material pattern or improving process efficiency.

An exemplary embodiment of the present invention provides a reverse offset printing apparatus, including:

a printed film supplying unit and a printed film collecting unit for continuously supplying a printed film;

a printed film supporting unit provided between the printed film supplying unit and the printed film collecting unit;

a printing roll for transferring a printed matter pattern to the printed film on the printed film supporting unit, in which the printing roll is provided so that a progress direction of the printed film is parallel to a rotation direction of the printing roll at a place where the printed matter pattern is transferred;

a coating unit coating a printed matter on the printing roll; and

a cliché provided on a stage for mounting the cliché in order to form the printed matter pattern on the printing roll.

In the present invention, the printed film supplying unit may be an unwinder and the printed film collecting unit may be a rewinder.

Another exemplary embodiment of the present invention provides a reverse offset printing method, including:

1) supplying a printed film on a printed film supporting unit provided between a printed film supplying unit and a printed film collecting unit, by using the printed film supplying unit and the printed film collecting unit which can continuously supply the printed film;

2) coating a printed matter on a printing roll;

3) forming a printed matter pattern on the printing roll by contacting the printing roll coated with the printed matter with the cliché;

4) transferring the printed matter pattern coated on the printing roll on the printed film supplied from the printed film supplying unit and the printed film collecting unit; and

5) collecting the printed film which is printed with the printed matter pattern in the printed film collecting unit and supplying the printed film which is not printed with the printed matter pattern from the printed film supplying unit to the printed film supporting unit, by driving the printed film supplying unit and the printed film collecting unit.

According to the exemplary embodiments of the present invention, printed films can be continuously supplied by using a printed film supplying unit and a printed film collecting unit which can be continuously driven.

According to the exemplary embodiments of the present invention, a printed matter pattern can be transferred to the printed film by using a printing roll provided so that a progress direction of the printed film which is continuously supplied during printing and a rotation direction of the printing roll are parallel to each other at a place where the printed matter pattern is transferred, such that it is possible to perform continuous printing or intermittent and continuous printing.

According to the exemplary embodiments of the present invention, it is possible to largely improve process efficiency.

According to the exemplary embodiments of the present invention, a printed film can be efficiently fixed and aligned by additional configurations to be described below.

According to the exemplary embodiments of the present invention, it is possible to efficiently provide a precisely fine pattern.

### BRIEF DESCRIPTION OF THE DRAWINGS

FIG. 1 is an exemplified diagram illustrating a reverse offset printing process.

FIG. 2 is an exemplified diagram illustrating a printing apparatus according to an exemplary embodiment of the present invention.

FIG. 3 is an exemplified diagram illustrating a printing apparatus according to another exemplary embodiment of the present invention.

FIGS. 4 and 5 are cross-sectional views illustrating a printed film supporting unit of the printing apparatus according to the exemplary embodiment of the present invention.

FIG. 6 is a plane view illustrating a printed film supporting unit of the printing apparatus according to the exemplary embodiment of the present invention.

FIGS. 7 and 8 are cross-sectional views illustrating the printed film supporting unit shown in FIG. 6.

FIG. 9 is an exemplified diagram illustrating a printed film nipping unit of the printing apparatus according to the exemplary embodiment of the present invention.

FIG. 10 is a diagram illustrating an operation example of a position controller of a stage for mounting a cliché of the printing apparatus according to the exemplary embodiment of the present invention.

### DETAILED DESCRIPTION

Hereinafter, exemplary embodiments of the present invention will be described in detail.

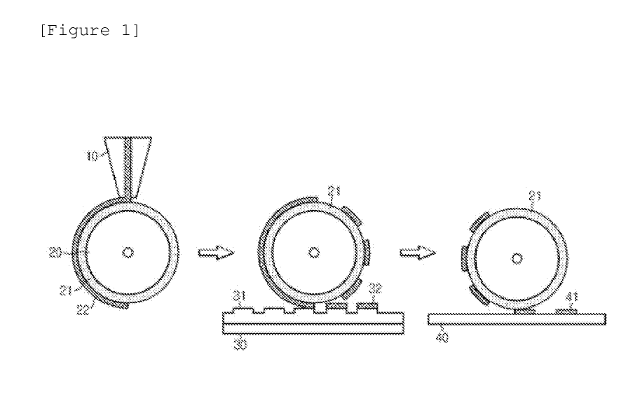

A printing apparatus and a printing method according to an exemplary embodiment of the present invention are used in a reverse offset printing process and one example of the reverse offset printing process is shown in FIG. 1.

In FIG. 1, a printing roll includes a printing roll stage 20 and a blanket 21 provided so as to cover the surface of the printing roll stage. A printed matter 22 is coated on the blanket 21 of the printing roll by using a coating unit 10. Subsequently, the blanket 21 of the printing roll is in contact with a cliché 31 provided on a stage 30 for mounting the cliché to partially remove a printed matter pattern 32 from the blanket 21 of the printing roll, to thereby form a printed matter pattern 41 on the blanket 21. Thereafter, the blanket 21 of the printing roll is in contact with a printed object 40 to transfer the printed matter pattern 41 to the printed object 40.

The printing apparatus and method according to the present invention are suitable for the reverse offset printing method as described above and particularly, efficient in a method in which a film is used as the printed object.

The reverse offset printing apparatus according to the present invention includes:

a printed film supplying unit and a printed film collecting unit for continuously supplying a printed film;

a printed film supporting unit provided between the printed film supplying unit and the printed film collecting unit;

a printing roll for transferring a printed matter pattern to the printed film on the printed film supporting unit, in which the printing roll is provided so that a progress direction of the printed film is parallel to a rotation direction of the printing roll at a place where the printed matter pattern is transferred;

a coating unit coating a printed matter on the printing roll; and

a cliché provided on a stage for mounting the cliché in order to form the printed matter pattern on the printing roll.

In the present invention, as long as the printed film may be continuously supplied by driving the printed film supplying unit and the printed film collecting unit and the printed matter pattern to be printed may be transferred to the printed film, a material or a thickness of the printed film is not particularly limited.

A protective film may be adhered to one side or both sides of the printed film before the printed matter pattern is transferred. In the case where the protective film is adhered to the printed film, a rewinder for removing the protective film may further be included in order to remove the protective film from the printed film supplied from the printed film supplying unit.

Further, after the printed pattern is transferred to the printed film, in the case where an additional film such as a protective film needs to be laminated, an unwinder of the additional film may further be included. For example, after transferring the printed pattern, the protective film may be laminated on one side or both sides of a printed object.

A laminator of the additional film and the printed object may also be additionally included. In this case, the laminate of the printed film and the additional film is collected in a printed film collecting unit.

In the present invention, the printed film supplying unit and the printed film collecting unit may continuously supply the printed film so that the printed film progress in one direction. In the present invention, the printed film supplying unit may be an unwinder and the printed film collecting unit may be a rewinder. Hereinafter, the printed film supplying unit is exemplified as the unwinder and the printed film collecting unit is exemplified as the rewinder, but the configuration thereof is not particularly limited as long as the printed film can be continuously supplied.

The progress direction of the printed film may be adjusted according to positions of the printed film supplying unit and the printed film collecting unit or a layout of components of the printing apparatus. As described above, a guide roll may be used in order to adjust the progress direction of the printed film in a predetermined area. However, even in this case, a progress direction of an area before the printed matter pattern is transferred to the printed film or a progress direction of an area after the printed pattern is transferred to the printed film is not limited.

As necessary, the driving of the unwinder and the rewinder may be intermittently controlled. As a result, in the present invention, intermittent and continuous printing can be performed. In this specification, the term “intermittent and continuous printing” may be understood so that the printed matter pattern is transferred by continuously supplying the printed film mounted at the unwinder and the rewinder on the printed film supporting unit while the driving of the unwinder and the rewinder is intermittently controlled in a necessary step during the printing process. As described above, in order to control the driving, a driving controller of a printed film unwinder and a printed film rewinder may further be included. Further, a feeder for controlling a progress speed of the printed film may further be included.

The printed film rewinder may rewind the printed film by rotating a body having the same width as or larger width than the printed film. In this case, a position controller controlling a position of the printed film rewinder may further be included in a rotation axial direction of the printed film rewinder or a parallel direction to a width direction of the printed film. The position controller of the printed film rewinder may be an edge position controller (EPC). The printed film may be rewound at a proper position of the printed film rewinder by the position controller of the printed film rewinder.

In the present invention, the printed film supporting unit may be a plate type and may also be a roll type. Hereinafter, the present invention will be described with reference to drawings according to a form of the printed film supporting unit. However, the following description described with reference to the drawings just exemplify the present invention and the scope of the present invention is not limited thereto. The present invention will be described by dividing the printed film supporting unit into the plate type and the roll type.

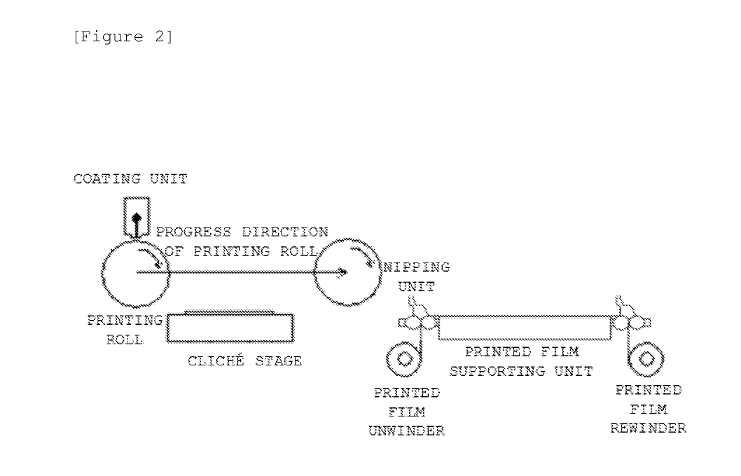

According to an exemplary embodiment of the present invention, the printed film supporting unit is a plate type. One example of the exemplary embodiment is shown in FIG. 2.

In the case where the printed film supporting unit is the plate type, the printed film is supplied on the printed film supporting unit by driving of the unwinder and the rewinder, and the driving of the unwinder and the rewinder may temporarily stop during a process in which the printed matter pattern is transferred on the printed film, that is, a set process. As described above, the printed matter pattern may be precisely transferred on the printed film by the temporary stop.

The printing apparatus according to the present invention may further include a driving controller of the unwinder and the rewinder which stops the driving of the unwinder and the rewinder when a print target area of the printed film is positioned on the printed film supporting unit and restarts the driving of the unwinder and the rewinder after the transfer of the printed matter pattern is completed.

The printing apparatus according to the present invention is advantageous to print a precise pattern on the printed film in the case of applying predetermined tension to the printed film. The tension applied to the printed film may be selected according to a material or a thickness of the printed film. For example, the printing apparatus may be driven so that the tension applied to the printed film may be 1 Kgf/m (film width) or more, 3 Kgf/m (film width) or more as necessary, and as a detailed example, 5 to 10 Kgf/m (film width) or more.

A maximum value of the tension applied to the printed film may be changed according to a material or a thickness of the printed film. For example, the tension of the printed film may be 50 Kgf/m (film width) or less and is not limited thereto. In the case where the tension of the printed film is more than 50 Kgf/m (film width), the printed film may be deformed.

The tension may be applied by the driving controller of the printed film unwinder and the printed film rewinder or a nipping unit to be described below.

In this connection, the printing apparatus according to the present invention may further include a tension measuring unit and/or a tension controller for detecting or controlling the tension of the printed film between the printed film supplying unit and the printed film collecting unit.

As one example, a load cell and a powder clutch may be included. The load cell serves to measure the tension of the printed film. The powder clutch serves to apply torque to a rotation speed of the roll. The load cell measures the tension of the printed film, and the powder clutch is connected to a motor to apply the torque to the rotation speed, thereby applying the tension. As another example, a dancer may further be included. The dancer may serve to mechanically control the tension.

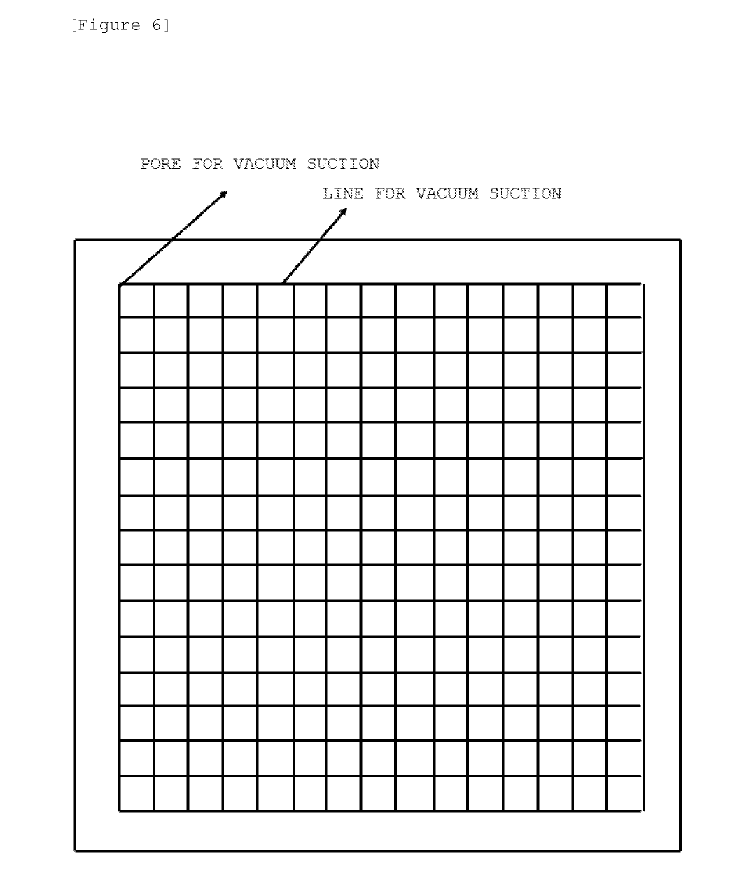

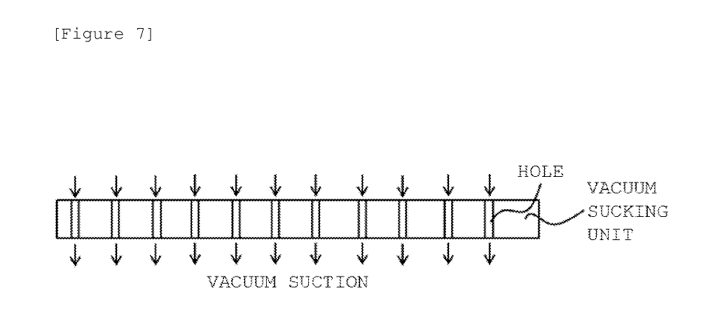

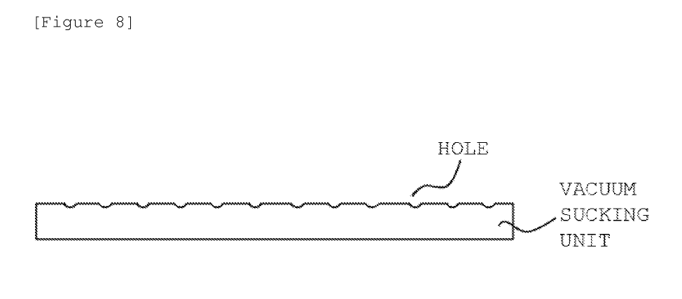

In the case where the printed film supporting unit is a plate, a vacuum sucking unit may be included in order to control the position of the precise pattern and perform alignment required for overlapped printing. The printed film disposed on the printed film supporting unit may be fixed by the vacuum sucking unit during the set process in which the printed matter is transferred. However, the set process in which the printed matter is transferred to the printed film can be performed if only tension having a predetermined magnitude is applied to the printed film without the vacuum sucking unit. The vacuum sucking unit may include a hole structure which can perform the vacuum suction. A cross-sectional structure of the vacuum sucking unit having the hole structure is shown in FIG. 7. The vacuum sucking unit may include a line structure with a groove on the surface of the vacuum sucking unit in order to increase efficiency of the vacuum suction due to the hole structure. A cross-sectional structure of the vacuum sucking unit having the line structure is shown in FIG. 8. The vacuum sucking unit including the hole structure and the line structure may have a structure shown in FIG. 6. FIG. 6 is a plan view of the vacuum sucking unit viewed from the top, and the vacuum sucking unit may have a hole structure at intersections of a lattice form and a line structure with a groove at the rest portion displayed in a straight line.

A shape and a diameter of the hole or a shape, a width, and a depth of the groove of the line structure are not particularly limited as long as the printed film is not deformed by the vacuum sucking unit and the printed film may be fixed to the printed film supporting unit.

For example, the diameter of the hole may be five times to fifteen times the thickness of the printed film, but is not limited thereto.

The width of the line structure may be one time to ten times the thickness of the printed film, but is not limited thereto.

The vacuum degree of the vacuum sucking unit is preferably smaller as compared with atmosphere pressure in order to improve the suction force.

In this case, the vacuum means a state where the pressure is lower than atmosphere pressure (760 mmHg), and the vacuum degree means a pressure of gas remaining in a vacuumized container by comparing a vacuum state for the atmosphere pressure.

The vacuum degree of the vacuum sucking unit is not particularly limited as long as the printed film is not deformed by the vacuum sucking unit and the printed film may be fixed to the printed film supporting unit.

For example, the vacuum degree of the vacuum sucking unit may be 5% or less of the atmosphere pressure.

The vacuum degree of the vacuum sucking unit may be 50 mmHg or less.

A minimum value of the vacuum degree of the vacuum sucking unit is not particularly limited as long as the printed film is not deformed by the vacuum sucking unit according to the kind and the thickness of the used printed film.

As described above, a porous plate or a porous film may be provided on the vacuum sucking unit, in order to prevent the printed film from being damaged by the vacuum sucking unit including the hole structure and the line structure as necessary, in which trace of the hole or the line structure remains or deformed. As long as the porous plate and the porous film have a porous structure so that the vacuum suction can be performed by the vacuum sucking unit and may prevent damage to the printed film, a structure or shape, a material, and the like thereof are not limited.

The porous plate and the porous film may be selected by those skilled in the art by considering the kind of printed film and the like. For example, an average pore size of the porous plate or the porous film may be 100 micrometers or less and particularly 30 micrometers or less. A minimum value of the average pore size of the porous plate or the porous film is not particularly limited as long as air can pass through the porous plate or the porous film and for example, may be 10 nm or more.

Porosity of the porous plate or the porous film is preferably larger and particularly, may be 10% or more.

In the present invention, between the unwinder and the printed film supporting unit, between the rewinder and the printed film supporting unit, or both between the unwinder and the printed film supporting unit and between the rewinder and the printed film supporting unit, a nipping unit blocking the tension to the printed film may further be included. The nipping unit is fixed to the printed film supporting unit to move together with the printed film supporting unit when aligning the printed film supporting unit. The nipping unit may move together with the printed film supporting unit in a vertical direction.

In the present invention, as described above, since the printed film are continuously supplied by the unwinder and the printed film rewinder, the position of the printed film needs to be controlled so that the pattern can be printed at an accurate position during the printing. In this case, in order to control the position of the printed film, the tension applied to the printed film needs to be blocked. In the present invention, the tension applied to the printed film may be blocked by the nipping unit. Further, the nipping unit may also serve to apply the tension of a predetermined level or more to the printed film.

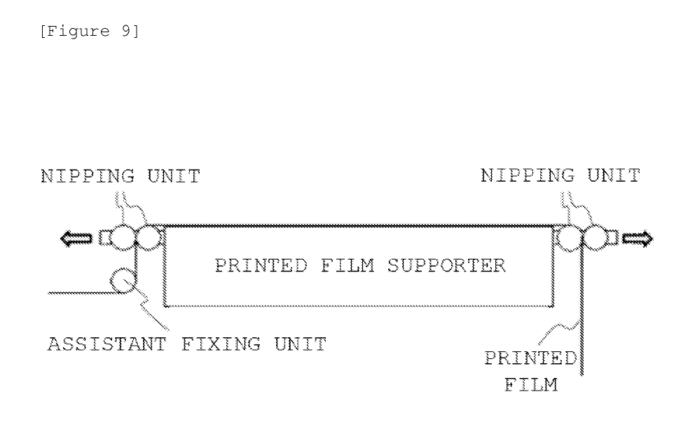

The nipping unit on the printed film supporting unit fixes the printed film while the printed matter pattern is transferred to the printed film and may move so as not to interrupt the progress of the printed film when the unwinder and the printed film rewinder are driven. To this end, a controller of the nipping unit may further be included. The nipping unit is shown in FIG. 9. In the nipping unit, two rolls are disposed to be adjacent to each other so as to fix the printed film and then at least one of two rolls moves so that a distance between the two rolls becomes farther, such that the printed film may proceed. For example, in the case of the nipping unit shown in FIG. 9, as the roll which is farther away from the printed film supporting unit moves in an arrow direction, the printed film may proceed.

The nipping unit may move downwards in order not to interrupt the movement path of the printing roll, or so that vacuum suction can be efficiently performed by the vacuum sucking unit of the printed film supporting unit during the printing. Further, the nipping unit may also move upwards so that a scratch does not occur on the lower surface of the printed film. Accordingly, the printing apparatus according to the present invention may include a driving unit for vertically moving the nipping unit.

In order not to interrupt the movement path of the printing roll, or in order that the scratch does not occur on the lower surface of the printed film, the printed film supporting unit may move upwards and downwards.

An assistant fixing unit may further be included so that the printed film can be stably supplied to the nipping unit. The assistant fixing unit may be provided between the unwinder and the nipping unit.

The printing apparatus according to the present invention may further include a position controller of the printed film supporting unit for aligning the printed film. Although not shown in the drawing, the position controller of the printed film supporting unit may be provided to be connected with the printed film supporting unit. The position controller of the printed film supporting unit may align the stage of the printed film supporting unit so that the printed matter pattern is transferred at an appropriate position on the printed film by the printing roll, before the printed matter pattern is transferred on the printed film. Further, as described above, the printed film may also vertically move through the position controller of the printed film supporting unit and as a result, it is possible to prevent the progress path of the printing roll from being interrupted and to prevent the scratch from occurring at the lower surface of the printed film.

The printing apparatus according to the present invention may further include a drying or curing unit provided between the printed film supporting unit and the rewinder. The drying or curing unit may dry or cure the printed matter pattern transferred on the printed film. The drying or curing unit may include a control means so as to dry or cure the printed matter pattern under an appropriate condition. In the present invention, since a printed matter has a film form, a drying or curing temperature may be controlled according to a film material. The printing apparatus according to the present invention may further include a second unwinder which is provided between the printed film supporting unit and the rewinder and supplies a film to be bonded with the printed film. A kind of the film supplied from the second unwinder is not particularly limited as long as the laminating with the printed film is required. For the laminating, a laminating means may further be included, before the printed film and the film supplied from the second unwinder are rewound around the rewinder. For example, a pressurizing means may further be included. The pressurizing means may be supplied through a structure with two rolls. Two films may be laminated by the pressurizing means.

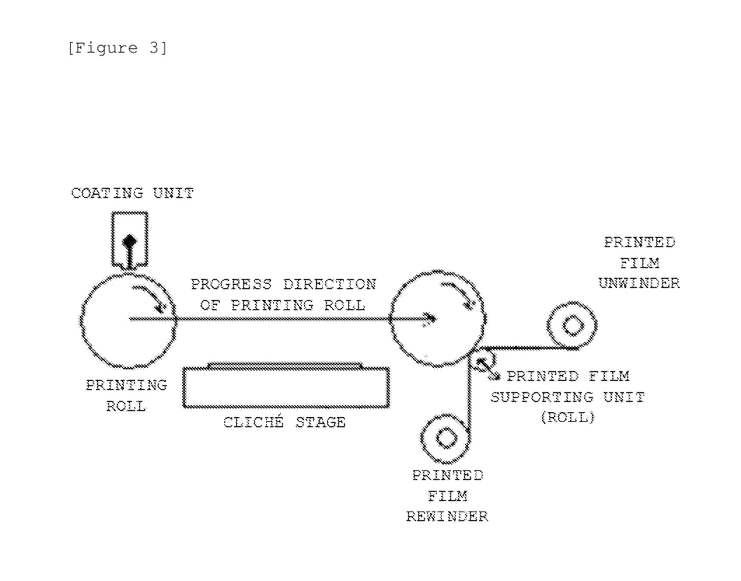

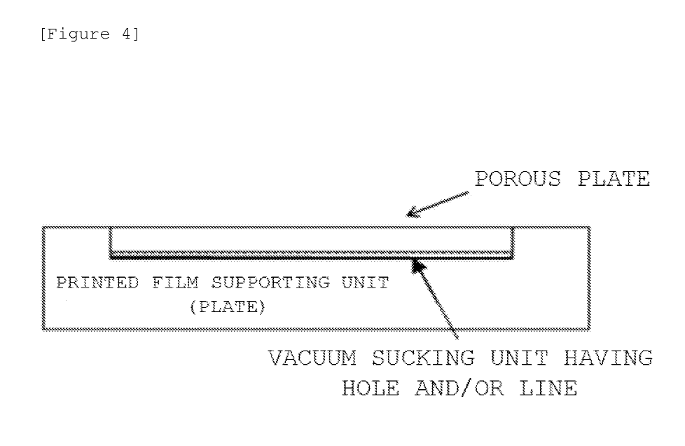

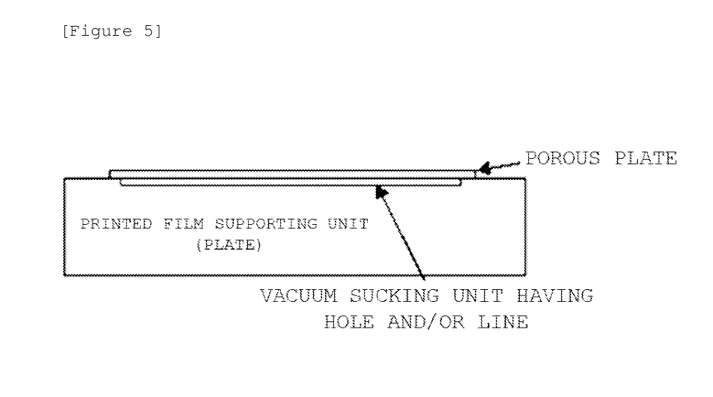

According to an exemplary embodiment of the present invention, the printed film supporting unit may be a roll type. One example of the exemplary embodiment is shown in FIG. 3.

In FIG. 3, the printing roll is provided so that the progress direction of the printed film supplied by driving the unwinder and the rewinder and the rotation direction of the printing roll are parallel to each other at a place where the printed matter pattern is transferred. The printing roll transfers the remaining printed matter pattern on the printed film disposed on the printed film supporting unit, after the printed matter is coated by the coating unit and the printed matter is partially removed by the cliché provided on the stage for mounting the cliché.

The printing roll is provided to freely move among a place where the printed matter is coated on the printing roll by the coating unit, a place where the printed matter pattern is formed on the printing roll by the cliché, and a place the printed matter pattern is transferred to the printed film.

In this case, unlike the case where the printed film supporting unit has the plate, the driving of the unwinder and the rewinder does not stop even while the printed matter pattern is transferred on the printed film. Further, in the case where the printed film supporting unit is the roll, the nipping unit is not required unlike the case of the plate.

In the case where the printed film supporting unit is the roll type, the driving speed of the roll which is the printed film supporting unit may be synchronized with the driving speed of the printing roll which transfers the printed matter pattern. That is, a linear speed driving the roll and a linear speed driving the printing roll are the same as each other. Accordingly, the precise pattern may be transferred. In this case, when calculating the driving speed of the printing roll, the driving speed may be calculated based on the entire printing roll including the blanket.

In addition, like the position controller controlling the position of the printed film and the rewinder, the position controller of the printed film supporting unit, the printed film tension controller, the driving controller of the unwinder and the rewinder, the assistant fixing unit, the drying or curing unit, the second unwinder, the film laminating means, and the like, the description of the case where the printed film supporting unit is the plate may be applied to the case where the printed film supporting unit is the roll. In the case where the printed film supporting unit is the roll type, the precise pattern may be transferred by controlling the pressure between the printing roll and the roll type printed film supporting unit. In the case where the printed film supporting unit is the roll type, the vacuum sucking unit is not required.

In FIG. 2, the printing roll is provided so that the progress direction of the printed film supplied by driving the unwinder and the rewinder and the rotation direction of the printing roll are parallel to each other at a place where the printed matter pattern is transferred. The material and the configuration thereof are not particularly limited as long as the printing roll transfers the remaining printed matter pattern on the printed film disposed on the printed film supporting unit, after the printed matter is coated by the coating unit and the printed matter is partially removed by the cliché provided on the stage for mounting the cliché.

For example, the printing roll may include a roll type supporter and a blanket covering the outer surface of the roll type supporter. Herein, a material, a thickness, or a surface characteristic of the blanket may be selected depending on a print composition to be used and the kinds of cliché and printed film. For example, a silicon-based rubber may be used as the blanket. The blanket and the roll type supporter may be adhered to each other with an adhesive or an adhesive tape, but may also be adhered to each other through an adhesive force between materials of the roll type supporter and the blanket and may also be adhered to each other by using a physical fixing method.

The printing roll may be designed to be driven in a vertical direction so as to be applied to the set process after being applied to the off process. Further, the stage for mounting the cliché or the printed film supporting unit may also be designed to be driven in a vertical direction.

The cliché may include align marks having two dots or more. The shape of the align marks is transferred to the printed film by a print composition. As long as the align marks may detect the position of the cliché so as to control the position of the cliché according to an alignment degree, the size or the shape thereof does not matter. The align marks formed on the cliché may be formed to be engraved and may be formed to be embossed based on the form transferred to the printed film.

In the case where the align marks is two or more, the position where the cliché is disposed may be accurately determined, and as necessary, align marks having three dots or more or four dots or more may also be included. Since the align mark is a mark for displaying a position, the size or the shape thereof is not particularly limited as long as the align mark may be detected by a means for detecting the align mark, for example, a camera. As described above, by forming the align mark on a cliché substrate, even in the case where an opaque material is used as the printed film, alignment having high accuracy may be implemented.

In this case, the stage for mounting the cliché may further include an align camera for recognizing the align mark on the cliché and a position controller of the stage for mounting the cliché. The position controller of the stage for mounting the cliché may control a position on the plane. For example, the position controller of the stage for mounting the cliché may have a configuration for controlling fine positions of the stage for mounting the cliché in three positions, that is, an x-directional position, a y-directional position, and a seta (θ)-directional position. Herein, when the x direction is any one direction on the plate surface of the stage for mounting the cliché, for example, a horizontal direction of the stage for mounting the cliché, the y direction means a direction perpendicular to the x direction on the plate surface of the stage for mounting the cliché, for example, a vertical direction of the stage for mounting the cliché, and the seta (θ) direction means an angle on the plate surface of the stage for mounting the cliché. As described above, the configuration thereof is not particularly limited as long as the position on the plane of the stage for mounting the cliché may be controlled.

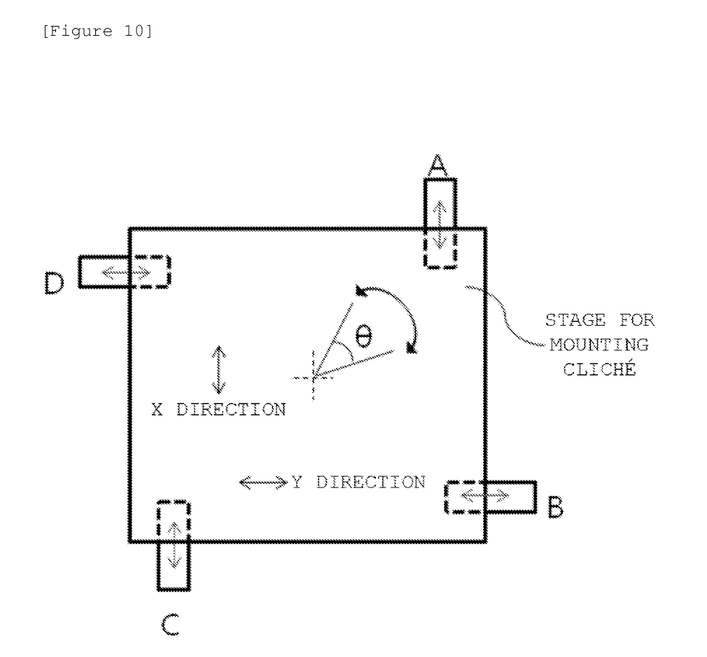

One example of a position controlling method of the stage for mounting the cliché is shown in FIG. 10. The position controller of the stage for mounting the cliché may include A, B, C, and D. Each of the A, B, C, and D is disposed around each apex of the stage for mounting the cliché to move in an arrow direction displayed in red and control the position of the stage for mounting the cliché. That is, the positions of the A and C are controlled in the y direction and the positions of the B and D are controlled in the x direction. If the A and C have the movement in the same direction, the stage for mounting the cliché moves in the y direction, and if the B and D have the movement in the same direction, the stage for mounting the cliché moves in the x direction. However, if the movement of the A and C is in the opposite direction or the movement of the B and D is in the opposite direction, the stage for mounting the cliché moves in the theta (θ) direction.

As described above, the position of the cliché is detected by the align camera, and if the position is not suitable, the fine position may be controlled by the position controller of the stage for mounting the cliché. Whether or not the position of the cliché is suitable may be verified by determining the position of the align mark of the printed pattern which is transferred to the printed film.

The printing apparatus according to the present invention may be used to print various patterns required for various electronic devices on the printed film. The printed film may also be used as a flexible substrate in the electronic devices, for example, a touch panel, various displays, and the like and may also be used as a film member. For example, the printed film may be used to print a conductive pattern, an insulation pattern, a resist pattern, a color pattern, a black matrix pattern, and the like.

The printed film according to the present invention may have a printed pattern having a line width and a pitch which are required according to the use thereof. For example, the printed pattern may have a line width of 120 micrometers or less and particularly 1 to 120 micrometers. As one example, the printed film may include a printed pattern having a line width of 1 to 5 micrometers or a line width of 15 to 100 micrometers.

Further, the present invention provides a reverse offset printing method, including:

1) supplying a printed film on printed film supporting unit provided between a printed film supplying unit and a printed film collecting unit, by using the printed film supplying unit and the printed film collecting unit which can continuously supply the printed film;

2) coating a printed matter on a printing roll;

3) forming a printed matter pattern on the printing roll by contacting the printing roll coated with the printed matter with the cliché;

4) transferring the printed matter pattern coated on the printing roll on the printed film supplied by the printed film supplying unit and the printed film collecting unit; and

5) collecting the printed film which is printed with the printed matter pattern in the printed film collecting unit and supplying the printed film which is not printed with the printed matter pattern from the printed film supplying unit to the printed film supporting unit, by driving the printed film supplying unit and the printed film collecting unit.

At step 4), when the printed matter pattern is transferred on the printed film, a progress direction of the printed film supplied by the printed film supplying unit and the printed film collecting unit and a rotation direction of the printing roll are parallel to each other at a place where the printed matter pattern is transferred.

The reverse offset printing method may further include:

allowing the printing roll to move from a place where the printed matter is coated on the printing roll of step 2) to a place where the printed matter pattern is formed on the printing roll of step 3), after step 2);

allowing the printing roll to move from a place where the printed matter pattern is formed on the printing roll of step 3) to a place where the printed matter pattern is transferred on the printed film of step 4), after step 3); and

allowing the printing roll to move from a place where the printed matter pattern is transferred on the printed film of step 4) to a place where the printed matter is coated on the printing roll of step 2), after step 4).

When the printing roll moves, before and after the movement, the printing roll may freely move between the places as necessary, and the progress direction of the printing roll is not particularly limited as long as the printing roll may move to each of the places. For example, the printing roll may move in a direction parallel with the surface, a direction vertical to the surface, and the like.

In the case where the printed film supporting unit is the plate, the reverse offset printing method may further include blocking tension by nipping both ends of the printed film which is disposed on the printed film supporting unit, after step 1).

The reverse offset printing method may further include aligning a print target area of the printed film by controlling the position of the printed film supporting unit, after step 1).

The reverse offset printing method may further include vacuum-sucking the printed film on the printed film supporting unit, after step 1). In the case where both the aligning and the vacuum sucking are performed, the order is not particularly limited. The aligning and the vacuum sucking may be performed at the same time, and the aligning may also be performed after the vacuum sucking.

The reverse offset printing method may further include curing or drying the printed matter pattern which is printed on the printed film, before step 5).

The reverse offset printing method may further include laminating the printed film which is printed with the printed matter pattern with a second film, before step 5). In this case, at step 5), the printed film with the printed matter pattern and the second film are rewound around the rewinder together.

At step 4), tension of 1 Kgf/m (film width) or more, particularly 3 Kgf/m (film width) or more, and more particularly 5 to 10 Kgf/m (film width) or more may be applied to the printed film. The tension may be applied by controlling the driving of the nipping unit or the unwinder and the rewinder.

What is claimed is:

1. A reverse offset printing apparatus, comprising:
a printed film supplying unit and a printed film collecting unit for continuously supplying a printed film;
a printed film supporting unit provided between the printed film supplying unit and the printed film collecting unit;
a printing roll for transferring a printed matter pattern to the printed film on the printed film supporting unit, in which the printing roll is provided so that a progress direction of the printed film is parallel to a rotation direction of the printing roll at a place where the printed matter pattern is transferred;
a coating unit coating a printed matter on the printing roll; and
a cliché provided on a stage for mounting the cliché in order to form the printed matter pattern on the printing roll.

2. The reverse offset printing apparatus of claim 1, wherein the printing roll is provided to freely move among a place where the printed matter is coated on the printing roll by the coating unit, a place where the printed matter pattern is formed on the printing roll by the cliché, and a place where the printed matter pattern is transferred to the printed film.

3. The reverse offset printing apparatus of claim 1, wherein the reverse offset printing apparatus is driven by an intermittent and continuous printing method.

4. The reverse offset printing apparatus of claim 1, wherein the printed film supplying unit is an unwinder and the printed film collecting unit is a rewinder.

5. The reverse offset printing apparatus of claim 1, wherein the printed film supporting unit is a plate.

6. The reverse offset printing apparatus of claim 5, wherein the printed film supporting unit includes a vacuum sucking unit.

7. The reverse offset printing apparatus of claim 6, wherein the vacuum sucking unit includes a hole structure.

8. The reverse offset printing apparatus of claim 7, wherein the vacuum sucking unit further includes a line structure.

9. The reverse offset printing apparatus of claim 6, wherein a porous plate or a porous film is provided on the vacuum sucking unit.

10. The reverse offset printing apparatus of claim 5, further comprising:
a nipping unit provided between the printed film supplying unit and the printed film supporting unit, between the printed film collecting unit and the printed film supporting unit, or both between the printed film supplying unit and the printed film supporting unit and between the printed film collecting unit and the printed film supporting unit.

11. The reverse offset printing apparatus of claim 10, wherein the nipping unit fixes the printed film while the printed matter pattern is transferred to the printed film on the printed film supporting unit and is driven so as not to interrupt the progress of the printed film when the printed film supplying unit and the printed film collecting unit are driven.

12. The reverse offset printing apparatus of claim 1, wherein the printed film supporting unit is a roll.

13. The reverse offset printing apparatus of claim 1, wherein the printed film supplying unit and the printed film collecting unit are driven so as to apply tension to the printed film.

14. The reverse offset printing apparatus of claim 10, wherein the nipping unit is driven so as to apply tension to the printed film.

15. The reverse offset printing apparatus of claim 1, further comprising:
at least one of a position controller for controlling positions of the printed film and the printed film collecting unit, a driving controller of the printed film supplying unit and the printed film collecting unit, and a tension controller of the printed film.

16. The reverse offset printing apparatus of claim 1, further comprising:
a drying or curing unit provided between the printed film supporting unit and the printed film collecting unit.

17. The reverse offset printing apparatus of claim 1, further comprising:
a second unwinder and a film laminating means.

18. The reverse offset printing apparatus of claim 1, further comprising:
a position controller of the printed film supporting unit for aligning the printed film.

19. A reverse offset printing method, comprising:
1) supplying a printed film on a printed film supporting unit provided between a printed film supplying unit and a printed film collecting unit, by using the printed film supplying unit and the printed film collecting unit which can continuously supply the printed film;
2) coating a printed matter on a printing roll;
3) forming a printed matter pattern on the printing roll by contacting the printing roll coated with the printed matter with the cliché;
4) transferring the printed matter pattern coated on the printing roll on the printed film supplied from the printed film supplying unit and the printed film collecting unit; and
5) collecting the printed film which is printed with the printed matter pattern in the printed film collecting unit and supplying the printed film which is not printed with the printed matter pattern from the printed film supplying unit to the printed film supporting unit, by driving the printed film supplying unit and the printed film collecting unit.

20. The reverse offset printing method of claim 19, wherein at step 4), when the printed matter pattern is transferred on the printed film, a progress direction of the printed film supplied by the printed film supplying unit and the printed film collecting unit and a rotation direction of the printing roll are parallel to each other at a place where the printed matter pattern is transferred.

21. The reverse offset printing method of claim 19, further comprising:
allowing the printing roll to move from a place where the printed matter is coated on the printing roll of step 2) to a place where the printed matter pattern is formed on the printing roll of step 3), after step 2);
allowing the printing roll to move from a place where the printed matter pattern is formed on the printing roll of step 3) to a place where the printed matter pattern is transferred on the printed film of step 4), after step 3); and
allowing the printing roll to move from a place where the printed matter pattern is transferred on the printed film of step 4) to a place where the printed matter is coated on the printing roll of step 2), after step 4).

22. The reverse offset printing method of claim 19, further comprising:
aligning a print target area of the printed film by controlling the position of the printed film supporting unit; or vacuum-sucking the printed film on the printed film supporting unit, after step 1).

23. The reverse offset printing method of claim 19, further comprising:
curing or drying the printed matter pattern which is printed on the printed film; or laminating the printed film which is printed with the printed matter pattern with a second film, before step 5).

24. The reverse offset printing method of claim 19, wherein at step 4), tension of 1 Kgf/m (film width) or more is controlled to be applied to the printed film.

25. The reverse offset printing method of claim 19, further comprising:
blocking tension by nipping both ends of the printed film which is disposed on the printed film supporting unit, after step 1), in the case where the printed film supporting unit is a plate.
